(19) United States
(12) Patent Application Publication
(10) Pub. No.: US 2026/0296603 A1
(43) Pub. Date: Oct. 1, 2026

(54) SEMI-SUBMERSIBLE FLOAT FOR AN OFFSHORE WIND TURBINE

(71) Applicant: SAIPEM S.A., Puteaux (FR)

(72) Inventors: Frank ALIX, Puteaux (FR); Marie-Laure CLEMENT, Puteaux (FR); Jérémy PRIGENT, Puteaux (FR)

(21) Appl. No.: 19/489,792

(22) PCT Filed: Jun. 12, 2024
(86) PCT No.: PCT/FR2024/050769

§ 371 Date: Dec. 3, 2025

(30) Foreign Application Priority Data
Jun. 15, 2023 (FR) FR2306144

(51) Int. Cl. B63B 35/44; B63B 1/10; B63B 3/18; B63B 39/03

(52) U.S. Cl. CPC B63B 35/44; B63B 1/107; B63B 3/185; B63B 39/03; B63B 2035/446

(57) ABSTRACT

A semi-submersible float for an offshore wind turbine, includes at least three vertical columns, one of which is intended to receive a wind turbine mast, the vertical columns being connected together by pontoons each formed by a plurality of planar panels which are assembled together at the level of edges extending longitudinally between two columns, the edges of the pontoons being rounded and connected at each of their longitudinal ends to a column via a transition piece.

### TECHNICAL FIELD

The present invention relates to the general field of semi-submersible floats used for the offshore wind turbines. It more specifically concerns new semi-submersible float architecture.

### PRIOR ART

An offshore wind turbine aims to use wind energy in order to produce electricity using a turbine and an electric generator. There are two main types of offshore wind turbines: the fixed wind turbines which are implanted on the seabed (at shallow depths, typically less than 50 m), and the floating wind turbines which offer the advantage of being able to be built onshore and implanted in areas where the seabed depth typically exceeds 50 m.

The floating wind turbines concerned by the present invention comprise a turbine generally formed by a motor with several rotating blades on a horizontal axis and an electric generator coupled to the motor, the motor and the generator being fixed to an upper end of a vertical mast (or pylon). The lower end of the mast is mounted on a floating support structure (hereinafter referred to as float).

There are several main families of floats for offshore wind turbines: the semi-submersible floats, the immersed floats with tension legs (or TLP platforms for Tension-Leg Platform), the SPAR-type (for Single Point Anchor Reservoir) floats, the barge-type semi-submersible floats, and the floats with a pendulum counterweight.

The invention more specifically concerns the semi-submersible floats, that is to say steel or concrete foundations that generally take the form of a tripod with three (or four) cylindrical columns connected together by metal structures. The stability of the structure is ensured by a ballast system that allows the immersion of part of the foundation. This structure is characterized by its large size and reduced draft.

For example, reference can be made to publication FR 3,064,973 which describes a semi-submersible hybrid float structure including a central column and three external columns connected to the central column by pontoon-shaped branches.

This type of hybrid float has the advantage of being simple in design. However, such a construction has a significant weight which is strongly influenced by fatigue.

### DISCLOSURE OF THE INVENTION

There is therefore a need to have a semi-submersible float whose weight is optimized while meeting the fatigue criteria.

This aim is achieved thanks to a semi-submersible float for an offshore wind turbine, comprising at least three vertical columns, one of which is intended to receive a wind turbine mast, the vertical columns being connected together by pontoons each formed by a plurality of planar panels which are assembled together at the level of edges extending longitudinally between two columns, and in which, in accordance with the invention, the edges of the pontoons are rounded and are connected at each of their longitudinal ends to a column via a transition piece.

The float according to the invention is remarkable in that the edges of the pontoons are not sharp (that is to say at right angles) but are rounded, which allows limiting the stress concentrations and thus substantially improving the fatigue behavior of these areas.

Compared to right angles, this characteristic allows the float to meet the fatigue criteria while reducing its weight. As for the transition piece, it allows limiting the stresses in the area of connection between the pontoons and the columns of the float.

In addition, the invention allows improving the manufacturability of the pontoons by eliminating the continuity of the transverse stiffeners from one face of the pontoon to the other. The invention also allows improving the hydrodynamic behavior of the float by eliminating the side effects related to the sharp edges of the prior art.

Preferably, the rounded edges of the pontoons have quarter-circle geometry with a radius comprised between 100 and 1,500 mm.

Also preferably, the rounded edges of the pontoons have a thickness identical to that of the adjacent planar panels.

The transition piece may have one end that is rounded to connect to the longitudinal end of a rounded edge and an opposite end that forms a right angle.

The transition piece may be a piece obtained by one of the following techniques: forging, casting, shaping by press bending, and additive manufacturing changing from a triangular shape on one side to a rounded shape on its opposite side.

Preferably, each planar panel is provided on an inner face with two or three main longitudinal stiffeners and a plurality of secondary transverse stiffeners. This characteristic allows reducing the weight of the float and facilitating its manufacture.

In this case, the main stiffeners of each planar panel are preferably evenly spaced apart from each other by means of vertical partitions delimiting ballast areas.

According to one embodiment, the float comprises four vertical columns, including a central column (4) which is intended to receive the wind turbine mast, and three external columns are connected to the central column by lower pontoons.

In this embodiment, the external columns may each be formed by an assembly of planar panels. Alternatively, the external columns may each have a substantially cylindrical shape.

Still in this embodiment, the float may further comprise at least one gangway between an upper end of an external column and the central column. Such a gangway makes it easier to access the float (by helicopter, for example) or allows having a second access point for a maintenance vessel.

Still in this embodiment, the central column may have a frustoconical shape or a cylindrical shape.

According to one advantageous arrangement of the invention, the float comprises inside each pontoon and/or each external column a ballast area which can be adjusted to correct the trim of the float and improve the hydrodynamic behavior of the float.

### BRIEF DESCRIPTION OF THE DRAWINGS

FIG. 1 represents in perspective a semi-submersible float according to the invention.

FIG. 2 is a sectional view along II-II of FIG. 1.

FIG. 3 shows the stiffeners inside a pontoon of the float of FIG. 1.

### DESCRIPTION OF THE EMBODIMENTS

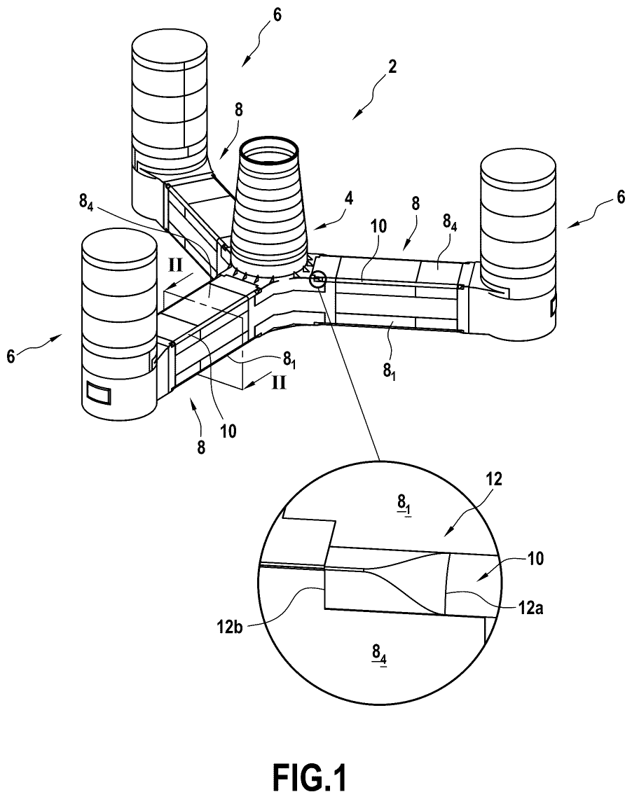

FIG. 1 represents in perspective a semi-submersible float 2 for an offshore wind turbine according to a first embodiment of the invention.

In this embodiment, the float 2 comprises four vertical columns whose central column 4 intended to receive a wind turbine mast (not represented in FIG. 1), and three external columns 6 which are connected to the central column 4 by branches forming lower pontoons 8.

More specifically, the lower pontoons 8 and the external columns 6 are angularly spaced apart from each other by 120° to form a star-shaped structure.

Of course, it is possible to envisage that the vertical columns of the float are connected together by upper pontoons and/or lower pontoons.

Moreover, at least the pontoons are formed by a plurality of planar panels which are assembled together. More specifically, in the embodiment of FIG. 1, each lower pontoon 8 is constituted by the assembly of four planar panels 81 to 84 forming a rectangular parallelepiped (only the planar panels 81 and 84 are visible in FIG. 1).

Of course, it is possible to envisage that the number of planar panels forming each pontoon is different (for example, five, six, etc.).

According to the invention, the planar panels of each pontoon are assembled together at the level of edges 10 which extend longitudinally between two columns and which are rounded by connecting at each of their longitudinal ends to a column via a transition piece 12.

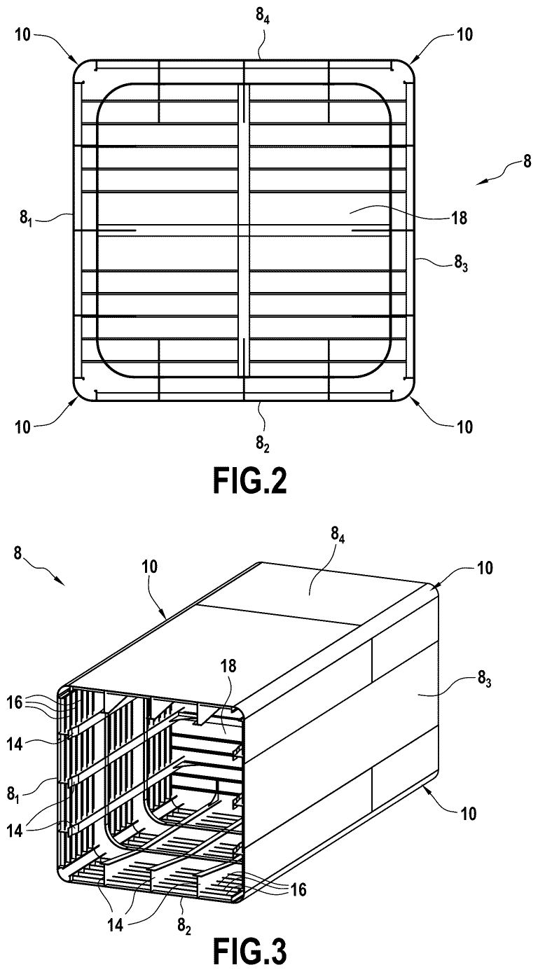

More specifically, as represented in FIG. 2, the edges 10 of the pontoons have a quarter-circle geometry with a radius comprised between 100 and 1,500 mm.

The rounded edges 10 of the pontoons connect at each of their two longitudinal ends to a vertical column of the float by means of a transition piece 12 making it possible to change from a quarter-circle shape to a right-angled shape.

To this end, as represented in the magnifying glass of FIG. 1, the transition piece 12 has an end 12a which is rounded to connect to the longitudinal end of a rounded edge 10 and an opposite end 12b which forms a right angle.

This transition piece 12 is a piece that can be obtained by one of the following techniques: forging, casting, shaping by press bending, and additive manufacturing changing from a triangular shape on one side to a rounded shape on its opposite side.

In addition, the rounded edges 10 of the pontoons 8 can have a thickness which is identical to or different from that of the adjacent planar panels.

According to one advantageous arrangement represented in FIG. 3, each planar panel 81 to 84 constituting the pontoons 8 is provided, on an inner face, with two or three main longitudinal stiffeners 14 and a plurality of secondary transverse stiffeners 16.

Thus, in the embodiment of FIG. 3, each planar panel 81 to 84 is provided with three main longitudinal stiffeners 14 evenly spaced from each other and a plurality of secondary transverse stiffeners 16.

Furthermore, the main stiffeners 14 of each planar panel are advantageously spaced apart from each other by means of vertical partitions 18 delimiting ballast areas.

Thus, inside each pontoon and/or each external column, at least one ballast area that can be adjusted to correct the trim of the float and improve its hydrodynamic behavior is provided.

It will be noted that in the embodiment of FIG. 1, the external columns 6 of the float 2 each have a substantially cylindrical shape. Of course, the invention also applies to the floats whose external columns are each formed by an assembly of planar panels in order to have a polyhedron shape (reference may be made to patent application FR 23 01328 filed on Feb. 13, 2023 by the Applicant).

It will also be noted that in the embodiment of FIG. 1, the central column 4 of the float 2 receiving the wind turbine mast has a truncated cone shape that widens downwards.

Of course, the invention also applies to the floats whose central column has a cylindrical shape.

It will also be noted that the float can advantageously further comprise at least one gangway (not forming part of the primary structure of the float and not represented in the figures) between an upper end of an external column and the central column in order to facilitate access to the float (by helicopter for example) or have a second access point for a maintenance vessel.

1.-12. (canceled)

13. A semi-submersible float for an offshore wind turbine, comprising four vertical columns including a central column which is intended to receive the wind turbine mast, and three external columns which are connected to the central column by lower pontoons each formed by a plurality of planar panels which are assembled together at the level of edges extending longitudinally between two columns,
wherein the edges of the pontoons are rounded, connected at each of their longitudinal ends to a column via a transition piece, and have a thickness identical to that of the adjacent planar panels.

14. The float according to claim 13, wherein the rounded edges of the pontoons have quarter-circle geometry with a radius comprised between 100 and 1,500 mm.

15. The float according to claim 13, wherein the transition piece has one end that is rounded to connect to the longitudinal end of a rounded edge and an opposite end that forms a right angle.

16. The float according to claim 15, wherein the transition piece is a piece obtained by one of the following techniques: forging, casting, shaping by press bending, and additive manufacturing changing from a triangular shape on one side to a rounded shape on its opposite side.

17. The float according to claim 13, wherein each planar panel of the pontoons is provided on an inner face with two or three main longitudinal stiffeners and a plurality of secondary transverse stiffeners.

18. The float according to claim 17, wherein the main stiffeners of each planar panel are evenly spaced apart from each other by means of vertical partitions delimiting ballast areas.

19. The float according to claim 18, wherein the external columns are each formed by an assembly of planar panels.

20. The float according to claim 18, wherein the external columns each have a substantially cylindrical shape.

21. The float according to claim 18, wherein it further comprises at least one gangway between an upper end of an external column and the central column.

22. The float according to claim 18, wherein the central column has a frustoconical shape.

23. The float according to claim 18, wherein the central column has a cylindrical shape.

24. The float according to claim 18, wherein it comprises inside each pontoon and/or each external column a ballast area which can be adjusted to correct the trim of the float and improve the hydrodynamic behavior of the float.
